(19) United States
(12) Patent Application Publication
(10) Pub. No.: US 2025/0095216 A1
(43) Pub. Date: Mar. 20, 2025

(54) METHOD AND APPARATUS FOR COMPRESSING 3-DIMENSIONAL VOLUME DATA

(71) Applicant: ELECTRONICS AND TELECOMMUNICATIONS RESEARCH INSTITUTE, Daejeon (KR)

(72) Inventors: Soo Woong KIM, Sejong-si (KR); Gun BANG, Daejeon (KR); Ji Hoon DO, Daejeon (KR); Seong Jun BAE, Daejeon (KR); Jin Ho LEE, Daejeon (KR); Ha Hyun LEE, Daejeon (KR); Jung Won KANG, Daejeon (KR)

(73) Assignee: ELECTRONICS AND TELECOMMUNICATIONS RESEARCH INSTITUTE, Daejeon (KR)

(21) Appl. No.: 18/889,565

(22) Filed: Sep. 19, 2024

(30) Foreign Application Priority Data
Sep. 19, 2023 (KR) 10-2023-0125068
Aug. 21, 2024 (KR) 10-2024-0111773

(51) Int. Cl. G06T 9/00

(52) U.S. Cl. CPC G06T 9/002; G06T 9/001

(57) ABSTRACT

This disclosure provides a method and apparatus for compressing 3-dimensional volume data. The method for encoding a TSDF volume may comprise: lossily encoding magnitude information of a Truncated Signed Distance Field (TSDF) volume based on a hyperprior model; and losslessly encoding sign information of the TSDF volume based on the hyperprior model, wherein the lossy encoding comprises selecting and entropy-encoding some elements from a latent vector for the TSDF volume based on selection information obtained through the hyperprior model.

### TECHNICAL FIELD

The present disclosure relates to a method and apparatus for compressing 3-dimensional volume data, and more particularly, to a method and apparatus for compressing 3-dimensional volume data by using selective latent code encoding.

### BACKGROUND

A Truncated Signed Distance Field (TSDF) fusion algorithm fuses distance information of a surrounding scene that a distance measurement system such as a depth sensor or a stereo camera observes from multiple viewpoints to generate a TSDF volume consisting of a plurality of voxels.

The TSDF volume is visualized as a 3-dimensional surface contained in data through volume rendering via raycasting or through mesh extraction using a Marching Cubes algorithm.

However, the quality of the visualized 3-dimensional surface is dependent on the resolution of a voxel grid, resulting in a large increase in the amount of data in the TSDF volume as the voxel grid has a higher resolution. Therefore, an efficient data reduction and encoding method is required in order to store or transmit a high-resolution TSDF volume.

### SUMMARY

An objective of the present disclosure is to provide a method for efficiently compressing TSDF volume data.

Another objective of the present disclosure is to provide a method for selecting latent representation elements adaptively to complexity when encoding a TSDF volume using latent representation.

Yet another objective of the present disclosure is to provide a method for reducing the number of latent representation elements to be encoded when encoding a TSDF volume using latent representation.

A further objective of the present disclosure is to provide a method for reconstructing TSDF volume data from the latent representation elements selectively encoded.

The method for encoding a TSDF volume according to an embodiment of the present disclosure may comprise: lossily encoding magnitude information of a TSDF volume based on a hyperprior model; and losslessly encoding sign information of the TSDF volume based on the hyperprior model, wherein the lossy encoding may include selecting and entropy-encoding some elements from a latent vector for the TSDF volume based on selection information obtained through the hyperprior model.

The method for decoding a TSDF volume according to another embodiment of the present disclosure may comprise: lossily decoding magnitude information of a TSDF volume based on a hyperprior model; and losslessly decoding sign information of the TSDF volume based on the hyperprior model, wherein the lossy decoding may include: deriving selected elements of a latent vector of the TSDF volume from a bitstream by entropy-decoding the bitstream based on probability distribution information for the latent vector, the probability distribution information being obtained through the hyperprior model; and generating sign probability information and magnitude information of voxels constituting the TSDF volume based on selection information for the latent vector obtained through the hyperprior model and the selected elements of the latent vector.

The apparatus for encoding a TSDF volume according to yet another embodiment of the present disclosure may comprise: a memory that stores data and one or more instructions; and one or more processors for executing the one or more instructions stored in the memory, wherein, by executing the one or more instructions, the one or more processors are configured to: lossily encode magnitude information of a Truncated Signed Distance Field (TSDF) volume based on a hyperprior model, wherein some elements of a latent vector for the TSDF volume are selected and entropy-encoded based on selection information obtained through the hyperprior model, and losslessly encode sign information of the TSDF volume based on the hyperprior model, wherein the sign information of the TSDF volume is entropy-encoded based on probability distribution information of the latent vector obtained through the hyperprior model.

According to one embodiment of the present disclosure, TSDF volume data can be efficiently compressed.

Moreover, it is possible to reduce the number of latent representation elements to be encoded and improve the efficiency of TSDF volume data compression, by lossily compressing the magnitude information of a TSDF volume, that is, by selecting and encoding some of latent representation elements to adapt to geometric complexity.

In addition, it is possible to prevent topological deformation of a mesh that can be extracted from a TSDF volume, by lossly compressing the magnitude information of the TSDF volume and losslessly encoding the sign information of the TSDF volume.

### BRIEF DESCRIPTION OF THE DRAWINGS

FIG. 1 illustrates a network structure for compressing a TSDF volume according to an embodiment of the present disclosure.

FIGS. 2A and 2B illustrate network configurations of a main encoder and main decoder which generate a latent vector from a TSDF volume and reconstruct the TSDF volume from the latent vector.

FIGS. 2C and 2D illustrate network configurations of a hyperprior encoder and hyperprior decoder which generate hyperprior information from a latent vector to estimate the distribution of the latent vector and reconstruct the latent vector from the hyperprior information.

FIG. 3 illustrates a TSDF volume encoding and decoding pipeline according to the present disclosure.

FIGS. 4A to 4E illustrate an encoding process for generating a bitstream by encoding a TSDF volume.

FIGS. 5A to 5G illustrate a decoding process for reconstructing a TSDF volume from a bitstream.

FIGS. 6A to 6C illustrate graphs comparing an embodiment according to the present disclosure and the conventional art.

FIG. 7 illustrates a block configuration of a TSDF volume generating apparatus according to an embodiment of the present disclosure.

FIG. 8 illustrates an operation flow chart for encoding a TSDF volume according to an embodiment of the present disclosure.

FIG. 9 illustrates an operation flow chart for decoding a TSDF volume from a bitstream according to an embodiment of the present disclosure.

FIG. 10 illustrates an operation flow chart for generating an image by using a TSDF volume according to an embodiment of the present disclosure.

### DETAILED DESCRIPTION

The present disclosure may be variously changed, and may have various embodiments, and specific embodiments will be described in detail below with reference to the attached drawings. However, it should be understood that those embodiments are not intended to limit the present disclosure to specific disclosure forms, and that they include all changes, equivalents or modifications included in the spirit and scope of the present disclosure.

Detailed descriptions of the following exemplary embodiments will be made with reference to the attached drawings illustrating specific embodiments. These embodiments are described so that those having ordinary knowledge in the technical field to which the present disclosure pertains can easily practice the embodiments. It should be noted that the various embodiments are different from each other, but do not need to be mutually exclusive of each other. For example, specific shapes, structures, and characteristics described here may be implemented as other embodiments without departing from the spirit and scope of the embodiments in relation to an embodiment. Further, it should be understood that the locations or arrangement of individual components in each disclosed embodiment can be changed without departing from the spirit and scope of the embodiments. Therefore, the accompanying detailed description is not intended to restrict the scope of the disclosure, and the scope of the exemplary embodiments is limited only by the accompanying claims, along with equivalents thereof, as long as they are appropriately described.

In the drawings, similar reference numerals are used to designate the same or similar functions in various aspects. The shapes, sizes, etc. of components in the drawings may be exaggerated to make the description clear.

In the present disclosure, it will be understood that, although the terms “first”, “second”, etc. may be used herein to describe various components, these components should not be limited by these terms. These terms are only used to distinguish one component from other components. For instance, a first component discussed below could be termed a second component without departing from the teachings of the present disclosure. Similarly, a second component could also be termed a first component. The term “and/or” includes any and all combinations of one or more of the associated listed items.

It will be understood that when a component is referred to as being “connected” or “coupled” to another component, it can be directly connected or coupled to the other component, or intervening components may be present. In contrast, it should be understood that when a component is referred to as being “directly connected” or “directly coupled” to another component, there are no intervening component present.

The components described in the embodiments are independently shown in order to indicate different characteristic functions, but this does not mean that each of the components is formed of a separate piece of hardware or software. That is, components are arranged and included separately for convenience of description. For example, at least two of the components may be integrated into a single component. Conversely, one component may be divided into multiple components. An embodiment into which the components are integrated or an embodiment in which some components are separated is included in the scope of the present specification, as long as it does not depart from the essence of the present specification.

The terms used in embodiments are merely used to describe specific embodiments and are not intended to limit the present disclosure. A singular expression includes a plural expression unless a description to the contrary is specifically pointed out in context. In the embodiments, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added. That is, it should be noted that, in the embodiments, an expression describing that a component “comprises” a specific component means that additional components may be included in the scope of the practice or the technical spirit of the embodiments, but do not preclude the presence of components other than the specific component.

In the embodiments, the term “at least one” means one of numbers of 1 or more, such as 1, 2, 3, and 4. In the embodiments, the term “a plurality of” means one of numbers of 2 or more, such as 2, 3, or 4.

Some components in the embodiments are not essential components for performing essential functions, but may be optional components for improving only performance. The embodiments may be implemented using only essential components for implementing the essence of the embodiments. For example, a structure including only essential components, excluding optional components used only to improve performance, is also included in the scope of the embodiments.

Hereinafter, the embodiments will be described in detail with reference to the accompanying drawings so that those having ordinary knowledge in the technical field to which the present disclosure pertains can easily practice the embodiments. In describing the embodiments, if it is determined that detailed descriptions of related known technologies may obscure the gist of the embodiments disclosed in the present specification, the detailed descriptions thereof will be omitted. It should be noted that the same reference numerals are used to designate the same or similar components throughout the drawings, and that redundant descriptions of the same components will be omitted.

The paper titled “Deep Implicit Volume Compression (CVPR2020)” published by Danhang et al discloses compression of a TSDF volume using a factorized-prior model. In this paper, the TSDF volume is divided into blocks each consisting of 8×8×8 voxels and compressed block by block. The signs of the TSDF volume are losslessly compressed, and the magnitudes thereof are lossily compressed, thereby preventing topological errors in the mesh geometry caused by compression.

In this paper, an input block (or block) is converted into a latent vector (or latent representation) through an encoding network, and all elements (or latent codes or latent elements) of the latent vector are entropy-encoded.

However, the encoding of all elements of the latent vector may have the following problems.

Although each input TSDF volume represents different geometric complexities, it is necessary to encode the same number of latent elements. Even a TSDF volume with a very simple geometric structure is allotted a latent vector of the same length (or with the same number of latent elements) as a TSDF volume with a very complex geometric structure, which increases bitrate.

That is, converting a TSDF volume into a latent vector of a fixed length (or with the same number of latent elements) and encoding it, regardless of geometric complexity, may result in a larger amount of computation in entropy coding and higher time complexity.

In view of these problems, the present disclosure proposes a method for adaptively adjusting the length of a latent vector (the number of latent elements constituting a latent vector) to the geometric complexity of a TSDF volume.

In an embodiment of the present disclosure, latent elements crucial to compression performance may be selectively encoded according to the geometric complexity of a TSFD volume.

In an embodiment of the present disclosure, a TSDF volume may be compressed based on a hyperprior model, and the hyperprior model may be designed in such a way as to predict a binary mask for selecting important (rate-distortion optimized) latent elements as well as the probability distribution of a latent vector. Only latent elements selected by the binary mask or selection information may be encoded.

For reference, the hyperprior model is used to improve entropy encoding efficiency and reduce bitrate, by adaptively predicting the distribution of latent representation to actual input.

Actual input data to be compressed may be distributed differently from a learning dataset on which an encoder for encoding the latent vector for input data is trained. For this reason, the distribution of the latent representations for the actual input data may be estimated by generating hyperprior information which stores the distribution information of the latent representations for the actual input data.

An entire TSDF volume X may be divided into, for example, TSDF blocks x (or TSDF volumes x) of bxbxb size (X={x1, x2, x3, . . . }) and encoded in units of TSDF blocks x.

Although the TSDF blocks x, too, are in the form of a 3-dimensional volume, encoded TSDF volume may be hereinafter called a TSDF block, in order to be distinguished from the entire TSDF volume X.

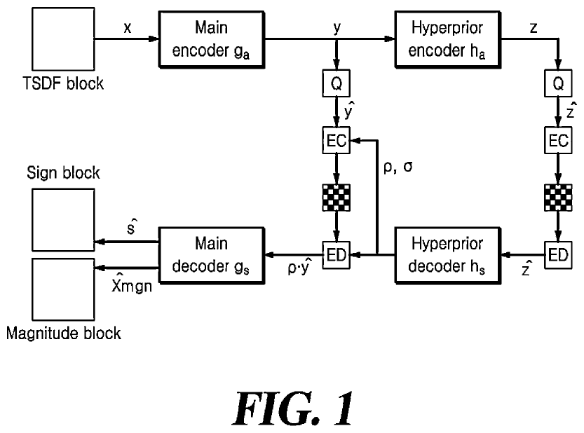

FIG. 1 illustrates a network structure for compressing a TSDF volume according to an embodiment of the present disclosure. For reference, the TSDF block x shown in FIG. 1, which is a 3-dimensional volume, is in the form of a rectangular plane for convenience.

As illustrated in FIG. 1, the TSDF block x may be converted into a latent vector (or latent representation) y by a main encoder gₐ, and the latent vector y may be converted into a hyperprior vector (or hyperprior representation or hyperprior information) z by a hyperprior encoder hₐ.

The hyperprior vector z is quantized (Q) into \hat{z}, and is then entropy-encoded (EC) and entropy-decoded (ED) and inputted into a hyperprior decoder hₛ as a quantized hyperprior vector \hat{z}.

The hyperprior decoder hₛ may output probability distribution information σ of the latent vector y and mask information ρ indicating important latent elements of the latent vector from the quantized hyperprior vector \hat{z}.

That is, a hyperprior model including a hyperprior encoder and hyperprior decoder may generate probability distribution information ρ of the latent vector y, which reflects the geometric complexity of an actual TSDF block represented by the latent vector, and mask information ρ of the latent vector.

Also, the latent vector y outputted from the main encoder gₐ is quantized (Q) into ŷ and then transforms into ρ·ŷ including important latent elements through entropy encoding (EC) and entropy decoding (ED) which are performed based on the probability distribution information σ and mask information ρ of the latent vector outputted by the hyperprior decoder hₛ.

The TSDF block x may be divided into sign s and magnitude x_{mgn} (x=s⊗x_{mgn}), and the main decoder gₛ may decode the sign information ŝ and magnitude information \hat{x}_{mgn} by taking ρ·ŷ as an input.

As illustrated in FIG. 1, the sign information and magnitude information of the TSDF block x may be decoded by using the hyperprior model.

Accordingly, once a bitstream is generated by entropy-encoding the latent elements selected from among the elements of the latent vector based on the mask information obtained from the hyperprior vector and the hyperprior model, the bitstream may be decoded to decode the sign and magnitude of the TSDF block x.

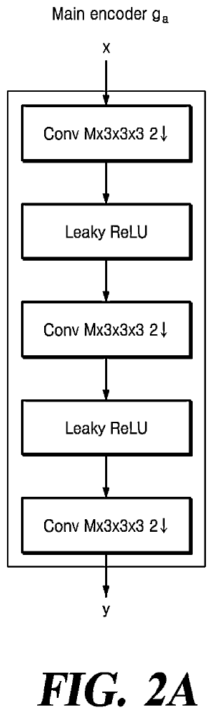

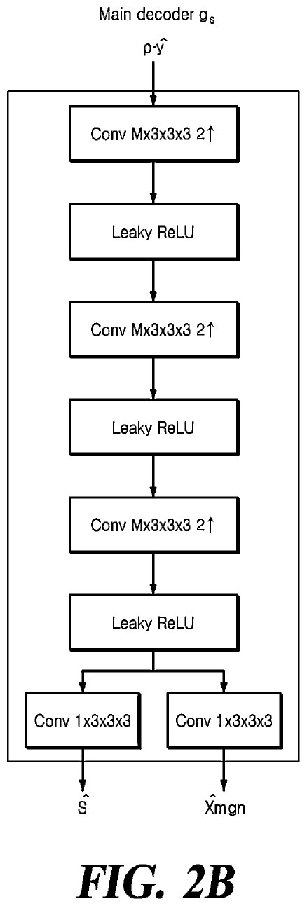

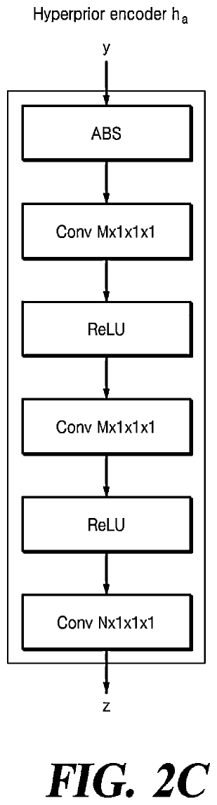

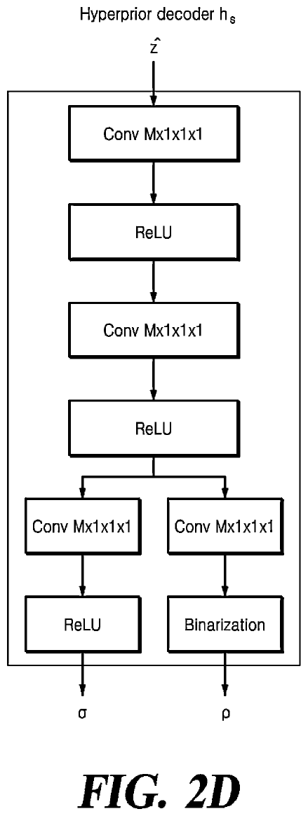

FIGS. 2A and 2B illustrate network configurations of a main encoder and main decoder which generate a latent vector from a TSDF volume and reconstruct the TSDF volume from the latent vector. FIGS. 2C and 2D illustrate network configurations of a hyperprior encoder and hyperprior decoder which generate hyperprior information from a latent vector to estimate the distribution of the latent vector and reconstruct the latent vector from the hyperprior information.

In FIG. 2A, a neural network (or latent vector conversion neural network) takes a TSDF block x as an input and outputs a latent vector y. The latent vector conversion neural network of FIG. 2A may use Stride 2 in a convolution layer having a 3×3×3 kernel and use a Leaky ReLU as a nonlinear layer.

The sizes of the kernel and stride used for the convolution layers in the latent vector conversion neural network and thus the numbers of convolution layers and nonlinear layers may be changed by taking into consideration rate-distortion optimization and/or supported hardware resources.

In a hardware or system environment in which computations can be substantially made within a given time, a large-sized kernel, a small value stride, and large numbers of convolution layers and nonlinear layers can be used. Conversely, in a poor computation environment, it is necessary to reduce the kernel size, make the stride larger and use fewer convolution layers and nonlinear layers.

Moreover, in a structure using a plurality of convolution layers, each convolution layer may use a kernel of a different size and/or a stride of a different value, or at least one convolution layer may use a kernel of a different size and/or a stride of a different value.

In FIG. 2B, a neural network (or latent vector reconstruction neural network) of the main decoder gₛ takes ρ·ŷ only including important latent elements as an input and outputs sign information ŝ and magnitude information \hat{x}_{mgn} of the TSDF block x.

The latent vector reconstruction neural network of FIG. 2B may allow the convolution layers in the latent vector conversion neural network to be replaced with transposed convolution layers. Also, the latent vector reconstruction neural network may include respective convolution layers for outputting the sign information and magnitude information of the TSDF block x, as illustrated in FIG. 2B.

A neural network (or hyperprior information conversion neural network) of the hyperprior encoder hₐ of FIG. 2C takes the latent vector as an input and outputs a hyperprior vector (or hyperprior information) z.

The hyperprior information conversion neural network of FIG. 2C may use three convolution layers having a 1×1×1 kernel, use two ReLUs as nonlinear layers, and use an absolute value calculation ABS in a first layer.

A neural network (or hyperprior information reconstruction neural network) of the hyperprior decoder hₛ of FIG. 2D takes a quantized hyperprior vector \hat{z} as an input and outputs probability distribution information σ and mask information ρ of the latent vector.

The hyperprior information reconstruction neural network of FIG. 2D may commonly use two convolution layers having a 1×1×1 kernel and two ReLUs as nonlinear layers, use a convolution layer having a 1×1×1 kernel and an ReLU nonlinear layer with respect to the output of the probability distribution information σ, and use a convolution layer having a 1×1×1 kernel and a binarization layer with respect to the output of the mask information ρ.

Meanwhile, since some of the latent vector elements are discarded and only important latent elements are encoded, based on the hyperprior model of FIG. 1, loss may happen in the sign information s and magnitude information \hat{x}_{mgn} of the decoded TSDF block x.

When loss happens in the sign information ŝ decoded from the TSDF block x, a mesh that can be extracted from the entire TSDF volume may be topologically deformed.

In an embodiment of the present disclosure, the sign information of the TSDF block x may be losslessly encoded by using a hyperprior model, and the magnitude information of the TSDF block x may be lossily encoded to adapt to the geometric complexity, thereby reducing the amount of data in the bitstream and fundamentally preventing topological deformation of a mesh extracted from the entire TSDF volume.

First, a method for selecting important latent elements when lossily encoding the magnitude information of the TSDF block x will be described.

The hyperprior decoder hₛ may provide separate output layers so as to generate two outputs, that is, probability distribution information σ and mask information ρ, as illustrated in FIG. 2D.

$$σ = {h}_{s}^{scale} ( f ) \qquad [ Equation 1 ]$$

$$ρ = {h}_{s}^{mask} ( f )$$

where f denotes a result prior to final output layers hₛ^{scale} and hₛ^{mask} of the hyperprior decoder hₛ.

The probability distribution information σ denotes a parameter representing the Gaussian distribution of a latent vector (more precisely, quantized latent vector ŷ), more specifically, the scale of the probability distribution of each of the latent elements constituting the quantized latent vector.

The mask information (or selection information) ρ is a binary vector with the same dimension as the latent vector ŷ, and a latent element selected to be encoded may have a value of 1 and a non-selected latent element has a value of 0.

When encoding the quantized latent vector ŷ, only latent elements ŷₛ selected according to the mask information ρ may be encoded.

When decoding, the selected latent vector ŷₛ, which includes only the selected latent elements, is reconstructed in the form of ρ·ŷ, that is, in such a way as to have the same dimension as the latent vector. Also, the main decoder gₛ may decode the sign information ŝ and magnitude information \hat{x}_{mgn} by taking ρ·ŷ as an input.

The output layer hₛ^{mask}(·) of the hyperprior decoder hₛ which generates the mask information ρ may perform different operations when training a network model and making an inference.

When training a network model on the mask information ρ, a differentiable quantization for mapping the mask information ρ to a binary vector may be designed as shown in the following Equation 2:

$$\tilde{ρ} = clamp ( {ρ}^{⌣} , - 0.5 , 0.5 ) \qquad [ Equation 2 ]$$

$$\overline{ρ} = \tilde{ρ} + U ( 0 , 1 )$$

$$n = stop\_gradient ( round ( \overline{ρ} ) - \overline{ρ} )$$

$$ρ = \overline{ρ} + n$$

The mask information ρ is clamped to a value between −0.5 and 0.5 by a clamp function first, a certain value having a uniform distribution between 0 and 1 is added to the clamped value by a uniform distribution function, which yields a distribution between −0.5 and 1.5, and the resulting value is obtained by (round(ρ̅)−ρ̅) operation under a non-differentiability condition (that is, the resulting value is changed to a value obtained by moving it in the negative direction away from zero by an amount of displacement from 0 or 1, whichever is nearer; for example, −0.2 is changed to 0.2, 0.4 is changed to −0.4, 0.7 is changed to 0.3, and 1.25 is changed to −0.25) and calculated as 0 or 1 by (p̅+n) operation.

When making an inference, no complex operation will not be performed, but quantization of the mask information ρ may be performed immediately as shown in Equation 3.

$$\tilde{ρ} = clamp ( {ρ}^{⌣} , - 0.5 , 0.5 ) \qquad [ Equation 3 ]$$

$$\overline{ρ} = \tilde{ρ} + 0.5$$

$$ρ = round ( \overline{ρ} )$$

That is, the mask information ρ may be clamped to a value between −0.5 and 0.5 by a clamp function first, the clamped value and 0.5 may be added together to yield a value between 0 and 1 and then calculated as 0 or 1 by a round function.

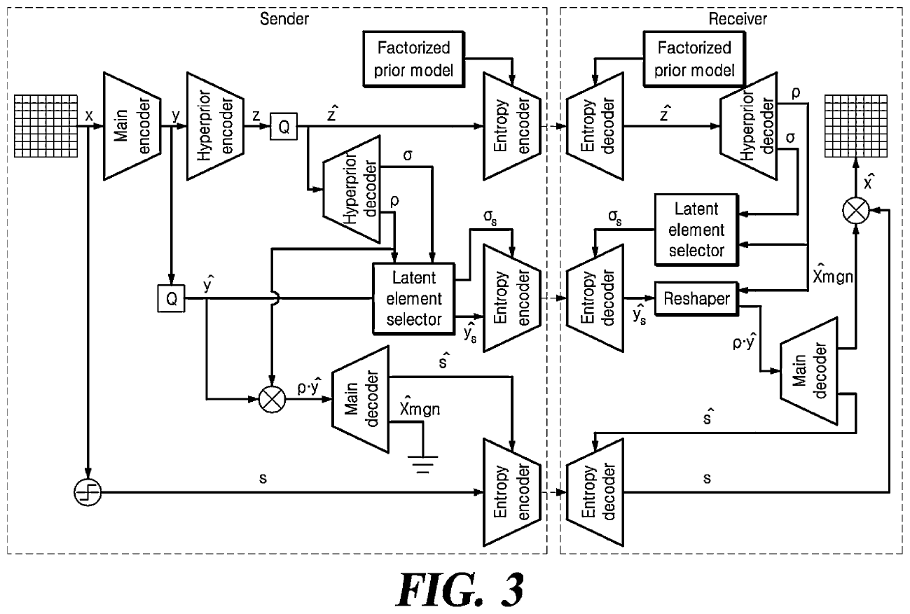

FIG. 3 illustrates a TSDF volume encoding and decoding pipeline according to the present disclosure.

A sender may encode a TSDF block x based on a hyperprior model to generate a bitstream and store it in a storage medium or send it, and a receiver may decode a received bitstream based on a hyperprior model to reconstruct the TSDF block \hat{x}.

As illustrated in FIG. 3, the sender (or TSDF block encoding apparatus) may include a main encoder gₐ, a main decoder gₛ, a hyperprior encoder hₐ, a hyperprior decoder hₛ, a latent code selector, a quantizer Q, and an entropy encoder.

As illustrated in FIG. 3, the receiver (or TSDF block decoding apparatus) may include an entropy decoder, a hyperprior decoder hₛ, a main decoder gₛ, a latent code selector, and a reshaper.

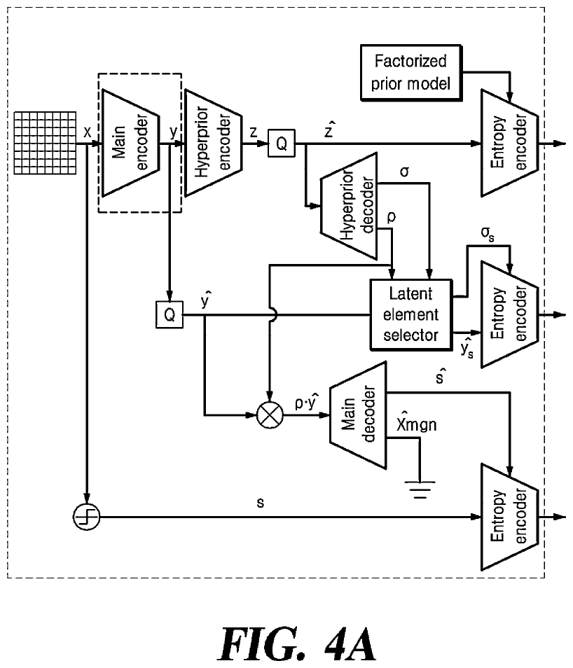

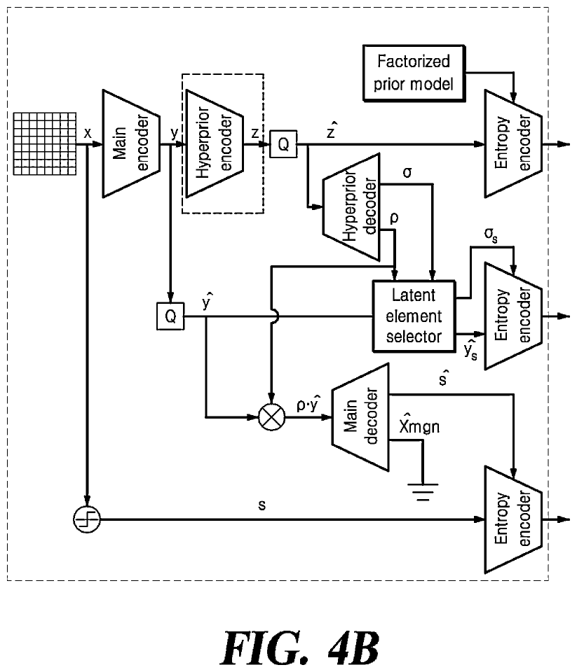

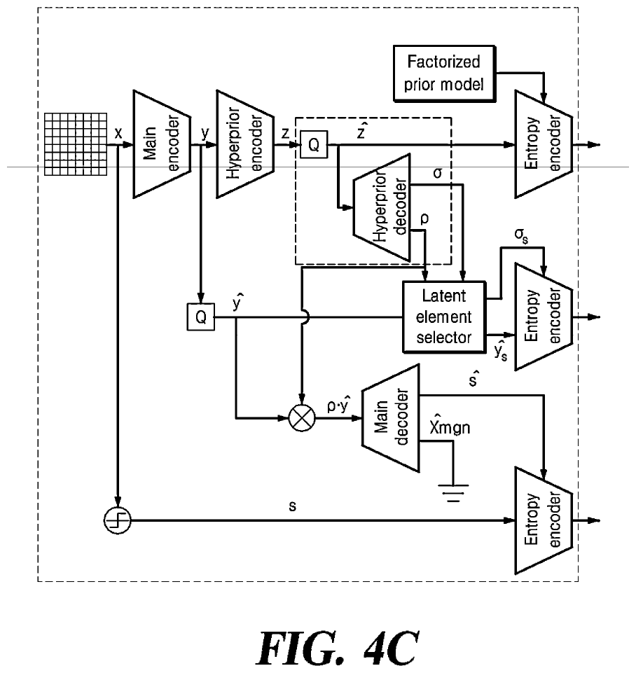

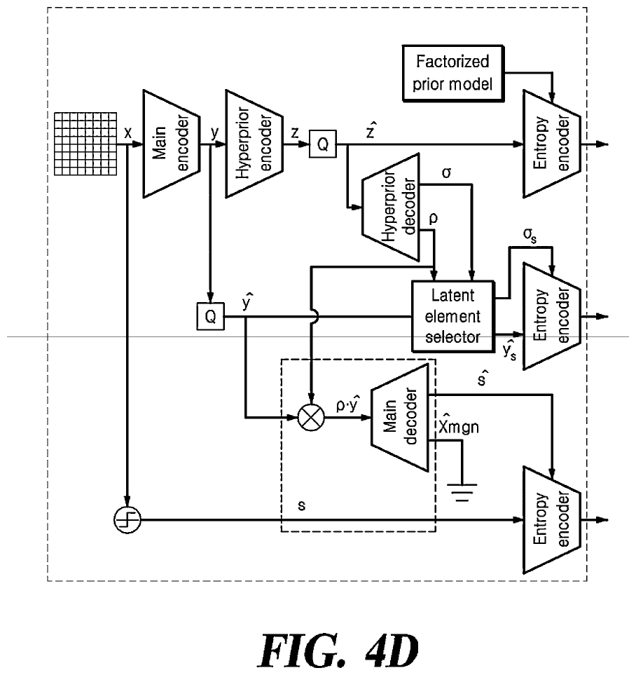

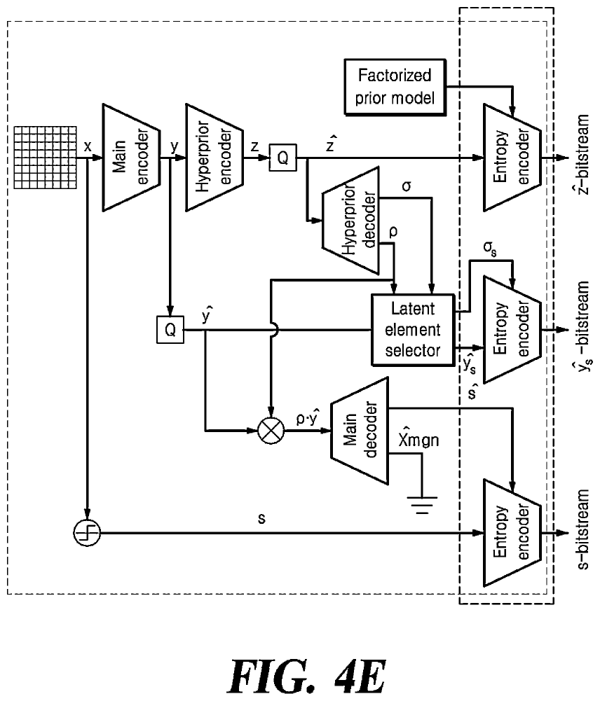

FIGS. 4A to 4E illustrate an encoding process for generating a bitstream by encoding a TSDF volume.

Referring to FIGS. 4A to 4E, a TSDF volume encoding pipeline will be described.

First, as illustrated in FIG. 4A, the main encoder gₐ converts an input TSDF block x into a latent vector (or latent representation) y (y=gₐ(x)).

As illustrated in FIG. 4B, the hyperprior encoder hₐ converts the latent vector y into a hyperprior vector (or hyperprior representation or hyperprior information) (z=hₐ(y)).

The hyperprior vector z is additional information extracted from the latent vector y, and it may be used to predict the distribution of the quantized latent vector ŷ and extract a mask for selectively encoding latent elements constituting the latent vector ŷ. That is, two kinds of information may be simultaneously extracted through a hyperprior model.

As illustrated in FIG. 4C, the hyperprior vector z is quantized, and the quantized hyperprior vector \hat{z} is reconstructed as probability distribution information σ corresponding to the Gaussian distribution scale of the latent vector and mask information ρ for selecting some of the latent elements constituting the latent vector.

As illustrated in FIG. 4D, the latent vector y is quantized into ŷ (ŷ=round(y)), and the quantized latent vector ŷ is multiplied by mask information ρ having a binary value of 0 or 1 (ρ·ŷ), whereby only the selected latent elements have proper values and the other latent elements have a value of 0. Afterwards, the main decoder gₛ reconstructs a TSDF sign ŝ from

$$ρ \hat{y} ( \hat{s} = {g}_{s} ( ρ \cdot \hat{y} ) ) .$$

Here, the TSDF sign ŝ has the same dimension as the TSDF block x which is an input, and each element of the decoded TSDF sign ŝ represents the conditional probability that each voxel constituting the TSDF block will have a positive sign.

The main decoder gₛ outputs not only the TSDF sign ŝ but also the TSDF magnitude \hat{x}_{mgn} from ρ·ŷ, but the TSDF magnitude is not used in the encoding apparatus.

As illustrated in FIG. 4E, the entropy encoder may generate a sign bitstream (s-bitstream) by entropy-encoding the sign s of the TSDF block based on a reconstructed TSDF sign ŝ (the conditional probability of the sign s). The sign s of the TSDF block x is losslessly compressed.

Also, the entropy encoder may generate a hyperprior bistream (\hat{z}-bitstream) by entropy-encoding the quantized hyperprior vector \hat{z} based on a distribution p_{\hat{z}}(\tilde{z}) according to a factorized prior model.

Also, the entropy encoder may generate selected latent elements ŷₛ which include only the latent elements selected from among the latent elements of the latent vector based on mask information ρ, and entropy-encode them to generate a selected latent element bitstream (ŷₛ-bitstream). In this case, a Gaussian distribution N (0, σₛ) may be used for the entropy encoding. Here, σₛ is probability distribution information of each of the selected latent elements (e.g., a scale value representing a Gaussian distribution).

A bitstream generated by the entropy encoder may be sent to the receiver via a storage medium or a transmission medium.

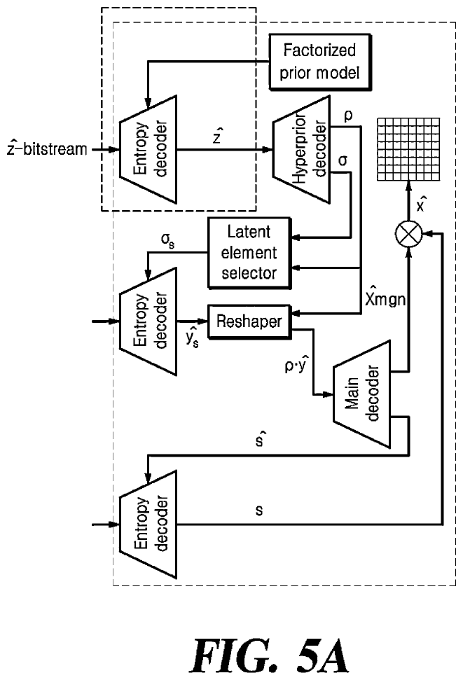

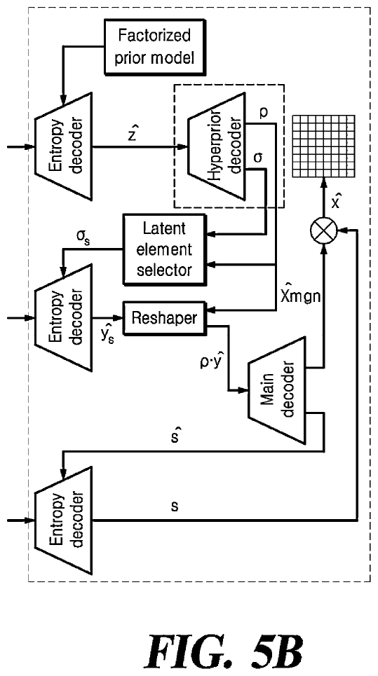

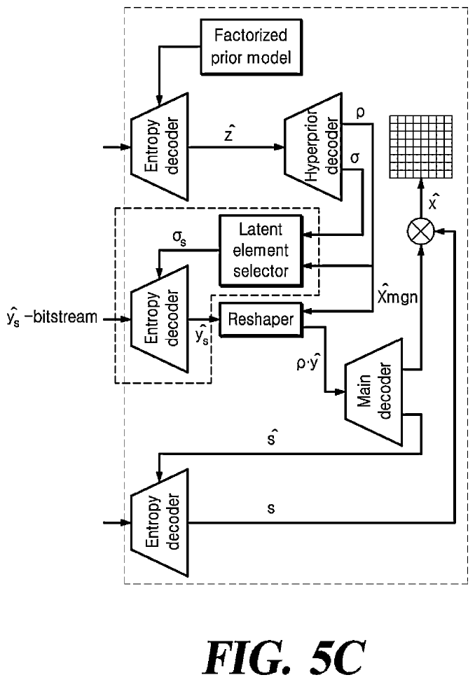

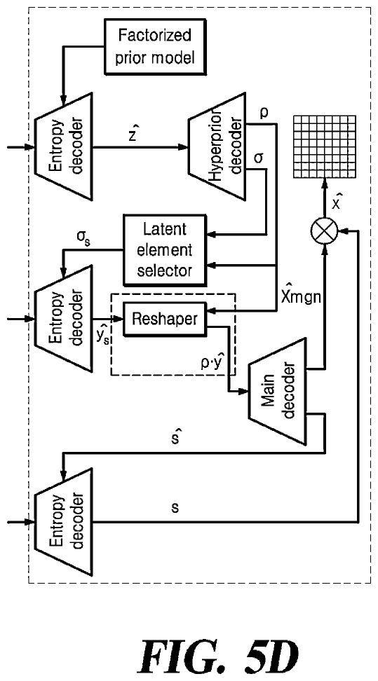

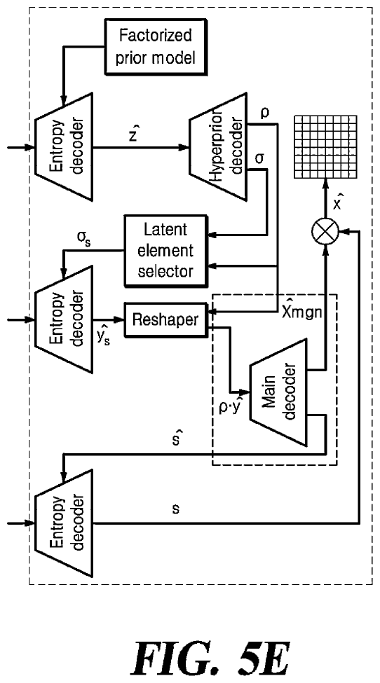

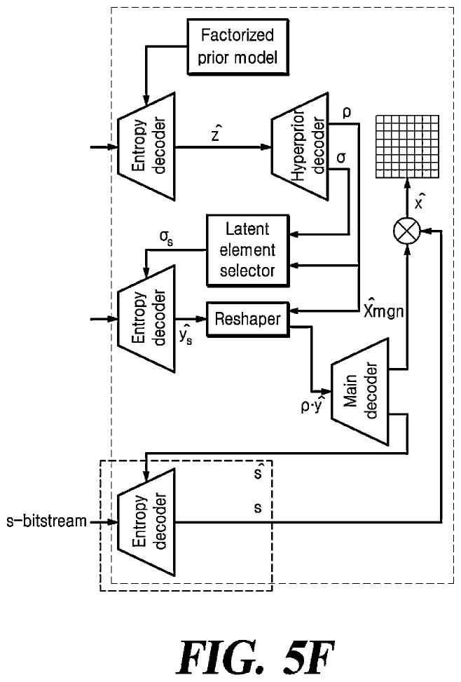

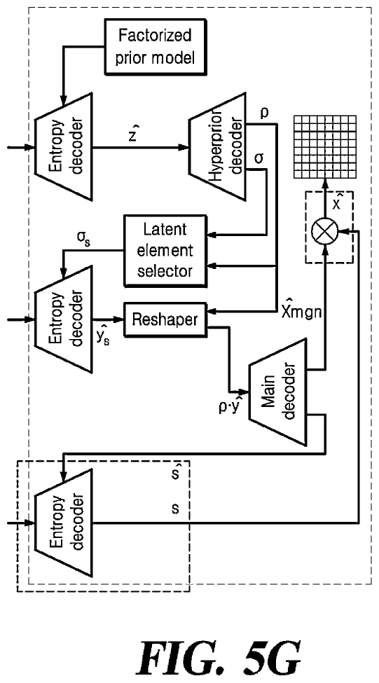

FIGS. 5A to 5G illustrate a decoding process for reconstructing a TSDF volume from a bitstream.

As illustrated in FIG. 5A, the entropy decoder may entropy-decode the hyperprior bitstream (\hat{z}-bitstream) based on the distribution p_{\hat{z}}(\hat{z}) according to the factorized prior model and reconstruct it as a quantized hyperprior vector \hat{z}. The factorized prior model may be shared between the encoder and the decoder.

As illustrated in FIG. 5B, the hyperprior decoder hₛ reconstructs the quantized hyperprior vector \hat{z} as probability distribution information σ and mask information ρ (σ,ρ=hs(\hat{z})).

As illustrated in FIG. 5C, the entropy decoder reconstructs the selected latent elements ŷₛ by entropy-decoding the selected latent element bitstream (ŷₛ-bitstream) based on the probability distribution information σₛ of the selected latent elements.

The latent element selector may derive the probability distribution information σₛ of the selected latent elements of the latent vector which are selected from the probability distribution information σ based on the mask information ρ and sent as a bitstream.

As illustrated in FIG. 5D, the reshaper sequentially arranges the selected latent elements ŷₛ, which only include selected latent elements, at positions where the mask information ρ indicates 1.

As illustrated in FIG. 5E, the main decoder gₛ predicts (or reconstructs) the TSDF sign ŝ and the TSDF magnitude \hat{x}_{mgn} from ρ·ŷ(ŝ, \hat{x}_{mgn}=gₛ(ρ·ŷ)).

As illustrated in FIG. 5F, the entropy decoder entropy-decodes the sign bitstream (s-bitstream) based on the predicted TSDF sign ŝ (the conditional probability of the sign s) to reconstruct the actual TSDF sign s. The TSDF sign s is entropy-decoded to have the same value as the actual value.

As illustrated in FIG. 5G, the TSDF block \hat{x} may calculated by multiplying the TSDF magnitude \hat{x}_{mgn} reconstructed by the main decoder gₛ and the entropy-decoded TSDF sign s in units of voxels constituting the TSDF block (\hat{x}=s⊗\hat{x}_{mgn}).

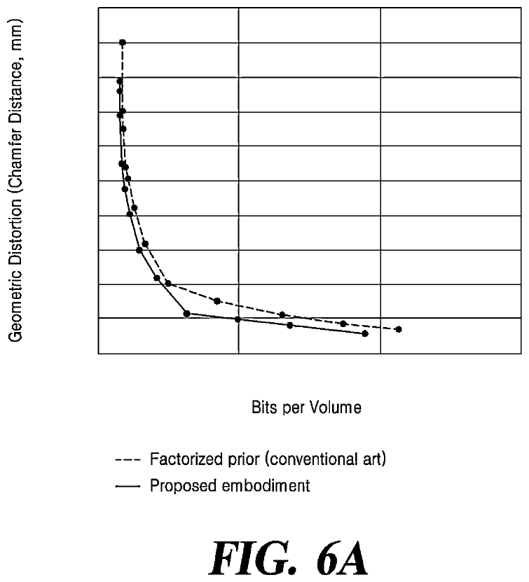

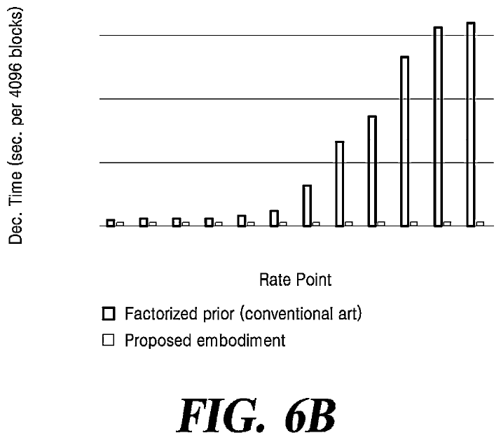

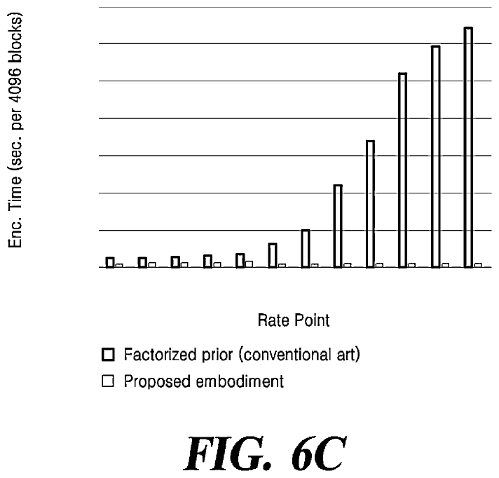

FIGS. 6A to 6C illustrate graphs comparing an embodiment according to the present disclosure and the conventional art.

In FIG. 6A, it can be seen that geometric distortion is reduced in the embodiment of the present disclosure in which important latent elements of a latent vector are selected and encoded, as compared to the conventional art (factorized prior).

Also, as illustrated in FIGS. 6B and 6C, it can be seen that the encoding time and the decoding time are significantly shortened in the embodiment of the present disclosure, as compared to the conventional art.

Thus, according to the embodiment of the present disclosure, a TSDF volume can be encoded and decoded at higher efficiency and faster rate than in the conventional art.

Meanwhile, a loss function for training the network of FIG. 1 which compresses a TSDF volume may be given by the following Equation 4:

$${L}_{R - D} = {D}_{\hat{x}} + λ \cdot ( {R}_{\hat{y}} + {R}_{\hat{z}} + {R}_{s} ) \qquad [ Equation 4 ]$$

The entire network of FIG. 1 may be trained such that the loss function in Equation 4 is minimum.

The distortion term D_{\hat{x}} in Equation 4 is the Mean Squared Error between the original TSDF volume and the reconstructed TSDF volume, which may be expressed by the following Equation 5, where b denotes the number of voxels in each direction of the TSDF volume.

$${D}_{\hat{x}} = \frac{1}{{b}^{3}} {\sum }_{d ∈ i , j , k}^{b} {( {\hat{x}}^{( d )} - {x}^{( d )} )}^{2} \qquad [ Equation 5 ]$$

The rate terms R_{ŷ}, R_{\hat{z}}, and Rₛ in Equation 4 may be expressed by Equation 6:

$${R}_{\hat{y}} = - \frac{1}{{N}_{y}} {\sum }_{i}^{{N}_{y}} {ρ}^{( i )} \cdot {log}_{2} ( {p}_{\hat{y} \vert \hat{z}} ( {\hat{y}}^{( i )} \vert {\hat{z}}^{( i )} ) ) \qquad [ Equation 6 ]$$

$${R}_{\hat{z}} = - \frac{1}{{N}_{z}} {\sum }_{i}^{{N}_{z}} {log}_{2} ( {p}_{\hat{z}} ( {\hat{z}}^{( i )} ) )$$

$${R}_{s} = - \frac{1}{{b}^{3}} {\sum }_{d ∈ i , j , k}^{b} ( {\overline{s}}^{( d )} \cdot {log}_{2} ( {\hat{s}}^{( d )} ) + ( 1 - {\overline{s}}^{( d )} ) \cdot {log}_{2} ( 1 - {\hat{s}}^{( d )} ) )$$

where ρ⁽ⁱ⁾ only uses the prediction rates of selected latent elements (that is, reflects the selection of latent elements when calculating R_{ŷ}), p_{\hat{z}}(\hat{z}⁽ⁱ⁾) denotes the distribution of a hyperprior vector predicted by a factorized prior model, and s̅ is defined as (s+1)/2, which means that a positive sign (+1) is adjusted to 1 and a negative sign (−1) is adjusted to 0. Here, the compression rate of encoded data can be improved by decreasing Rₛ.

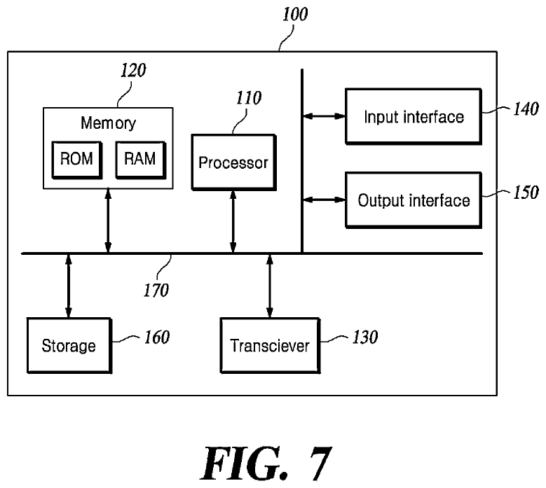

FIG. 7 illustrates a block configuration of a TSDF volume generating apparatus according to an embodiment of the present disclosure.

The TSDF volume generating apparatus 100 according to an embodiment of the present disclosure may include at least one processor 110, a memory 120 that stores at least one instruction executed through the processor 110 and data used to execute the instruction or generated when the instruction is executed, and a transceiver 130 connected to a network to perform communication.

The TSDF volume generating apparatus 100 according to an embodiment of the present disclosure may be connected with wires or wirelessly to a plurality of RGBD cameras and receive images and distance data obtained by the plurality of RGBD cameras.

The TSDF volume generating apparatus 100 may further include an input interface 140, an output interface 150, a storage 170, etc., and each of the components included in the TSDF volume generating apparatus 100 may be connected via a bus 170 and send and receive data to and from one another.

The processor 110 may execute program instructions stored in at least one of the memory 120 and the storage 160. The processor 110 may include a central processing unit (CPU), a graphics processing unit (GPU), or a dedicated processor on which a method according to an embodiment of the present disclosure is performed.

The memory 120 and the storage 160 each may include at least one of a volatile storage medium and a non-volatile storage medium. For example, the memory 120 may include at least one of read-only memory (ROM) and random access memory (RAM).

Here, the instructions may include an instruction that allows the processor 110 to receive a plurality of color images and a plurality of depth images from a plurality of cameras, an instruction that allows the processor 110 to calculate a TSDF volume from the plurality of depth images, an instruction that allows the processor 110 to encode the TSDF volume into a bitstream based on a hyperprior model, an instruction that allows the processor 110 to reconstruct the TSDF volume by decoding the bitstream, an instruction that allows the processor 110 to generate a 3D mesh from the TSDF volume by using a Marching Cubes algorithm, and an instruction that allows the processor 110 to map texture onto the generated 3D mesh.

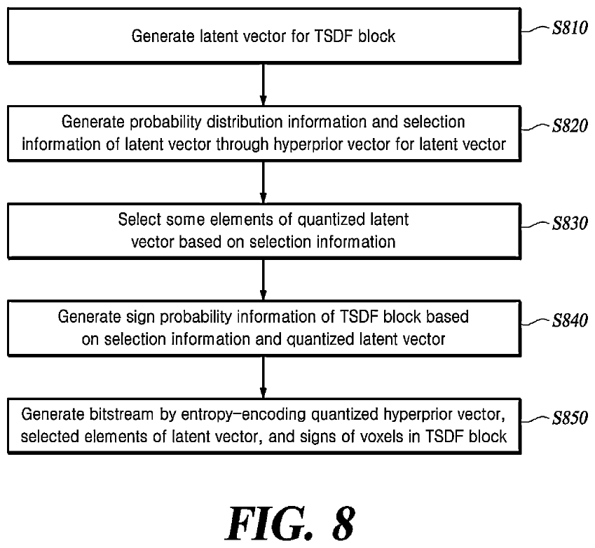

FIG. 8 illustrates an operation flow chart for encoding a TSDF volume according to an embodiment of the present disclosure.

The processor 110 of FIG. 7 may perform the operation of an encoding pipeline described with reference to FIGS. 4A to 4E according to the operation flow of FIG. 8.

The processor 110 may generate a latent vector y for a TSDF block x (S810).

The processor 110 may generate a hyperprior vector z from the latent vector y and generate probability distribution information σ and selection information (or mask information) ρ from the hyperprior vector z (S820).

The processor 110 may select some (important latent elements) of latent elements of a quantized latent vector ŷ based on the selection information ρ to generate selected latent elements ŷₛ (S830).

The processor 110 may generate a TSDF sign ŝ, i.e., sign probability information of the TSDF block by multiplying the selection information ρ which has a value of 0 or 1 and the quantized latent vector ŷ(ρ·ŷ) and decoding the product (S840).

Afterwards, the processor 100 may generate a bitstream by entropy-encoding the quantized hyperprior vector \hat{z}, the selected latent elements ŷₛ, and the sign s of the TSDF block (S850).

When entropy-encoding the quantized hyperprior vector \hat{z}, the selected latent elements § ŷₛ, and the sign s of the TSDF block, a distribution p_{\hat{z}}(\hat{z}) according to a factorized prior model, probability distribution information σₛ of each of the selected latent elements, and the sign probability information ŝ of the TSDF block may be used.

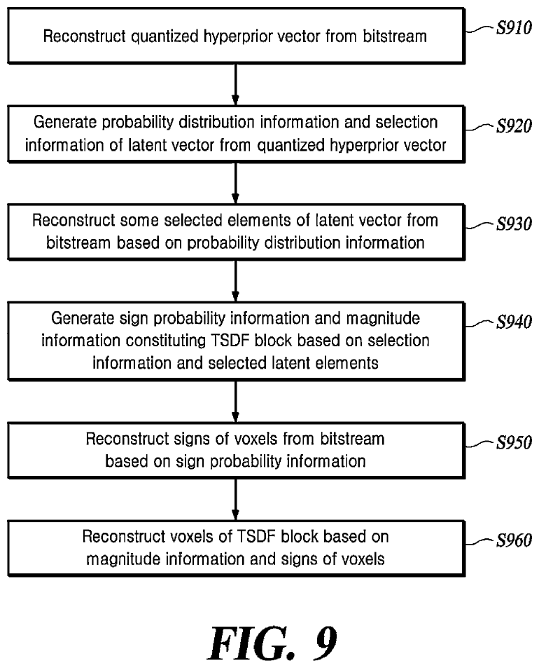

FIG. 9 illustrates an operation flow chart for decoding a TSDF volume from a bitstream according to an embodiment of the present disclosure.

The processor 110 of FIG. 7 may perform the operation of a decoding pipeline described with reference to FIGS. 5A to 5G according to the operation flow of FIG. 9.

The processor 110 may entropy-decode a transmitted bitstream and reconstruct it as a quantized hyperprior vector \hat{z} (S910), in which case a distribution p_{\hat{z}}(\hat{z}) according to a factorized prior model, which is shared with an encoder, may be used.

The processor 110 may reconstruct the quantized hyperprior vector \hat{z} as probability distribution information σ and selection information (or mask information) ρ (S920).

The processor 110 may obtain probability distribution information σₛ of latent elements selected based on the selection information ρ and use it to entropy-decode the bitstream and reconstruct the selected latent elements ŷₛ which only include the selected latent elements (S930).

The processor 110 may obtain ρ·ŷ by sequentially arranging the selected latent elements ŷₛ at positions where the selection information ρ indicates 1, and may decode p·ŷ to reconstruct the sign probability information ŝ and the magnitude information \hat{x}_{mgn} of the TSDF block (S940).

The processor 110 may use the sign probability information ŝ of the TSDF block to entropy-decode the bitstream and reconstruct the sign information s of the TSDF block (S950).

Afterwards, the processor 110 may multiply the magnitude information \hat{x}_{mgn} of the TSDF block and the sign information s of the TSDF block in units of voxels constituting the TSDF block, thereby reconstructing the TSDF block x\hat{ }(S960).

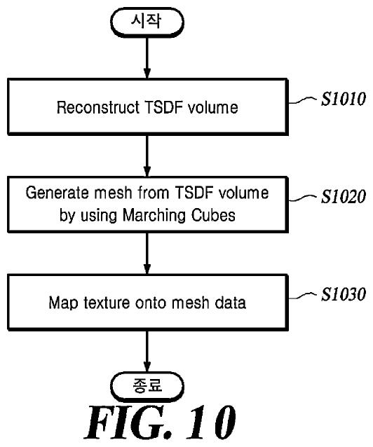

FIG. 10 illustrates an operation flow chart for generating an image by using a TSDF volume according to an embodiment of the present disclosure.

The processor 110 may reconstruct a TSDF volume according to the steps explained with reference to the operation flowchart of FIG. 9 from a transmitted bitstream (S1010).

The processor 110 may generate a 3D mesh from the reconstructed TSDF volume by using a Marching Cubes algorithm, for example (S1020).

The processor 110 may generate an image reflecting the distance from the viewer's direction by mapping texture onto the generated 3D mesh (S1030).

An embodiment of the present disclosure may be summarized as follows.

A method for encoding a Truncated Signed Distance Field (TSDF) volume according to an embodiment of the present disclosure may include: lossily encoding magnitude information of a TSDF volume based on a hyperprior model; and losslessly encoding sign information of the TSDF volume based on the hyperprior model, wherein the lossy encoding may include selecting and entropy-encoding some elements from a latent vector for the TSDF volume based on selection information obtained through the hyperprior model.

In an embodiment, the lossy encoding may include: converting the TSDF volume into a latent vector and converting the latent vector into a hyperprior vector for the hyperprior model; and decoding the hyperprior vector to generate the selection information and probability distribution information of the latent vector.

In an embodiment, the lossy encoding may include entropy-encoding the hyperprior vector based on a distribution according to a factorized prior model to generate a hyperprior bitstream.

In an embodiment, the selected elements of the latent vector may be entropy-encoded based on probability distribution information of the selected elements, among the probability distribution information of the latent vector.

In an embodiment, the lossy encoding may include generating sign probability information of the TSDF volume based on the selection information.

In an embodiment, the lossless encoding may include entropy-encoding the sign information of the TSDF volume based on the sign probability information to generate a sign bitstream.

A method for decoding a Truncated Signed Distance Field (TSDF) according to another embodiment of the present disclosure may include: lossily decoding magnitude information of a TSDF volume based on a hyperprior model; and losslessly decoding sign information of the TSDF volume based on the hyperprior model, wherein the lossy decoding may include: deriving selected elements of a latent vector of the TSDF volume from a bitstream by entropy-decoding the bitstream based on probability distribution information for the latent vector, the probability distribution information being obtained through the hyperprior model; and generating sign probability information and magnitude information of voxels constituting the TSDF volume based on selection information for the latent vector obtained through the hyperprior model and the selected elements of the latent vector.

In an embodiment, the lossy decoding may include: entropy-decoding the bitstream to generate a hyperprior vector for the hyperprior model; and decoding the hyperprior vector to generate the selection information and the probability distribution information.

In an embodiment, the generating of the sign probability information and the magnitude information may include performing an operation on the selection information and the selected elements of the latent vector to reconstruct the latent vector to an original dimension.

In an embodiment, the lossless decoding may include obtaining the sign information of the TSDF volume by entropy-decoding the bitstream based on the sign probability information.

In an embodiment, the method for decoding a TSDF volume may further include obtaining the TSDF volume by multiplying the magnitude information and the sign information of the TSDF volume.

An apparatus for encoding a TSDF volume according to yet another embodiment of the present disclosure may include: a memory that stores data and one or more instructions; and one or more processors for executing the one or more instructions stored in the memory, wherein, by executing the one or more instructions, the one or more processors are configured to: lossily encode magnitude information of a Truncated Signed Distance Field (TSDF) volume based on a hyperprior model, wherein some elements of a latent vector for the TSDF volume are selected and entropy-encoded based on selection information obtained through the hyperprior model, and losslessly encode sign information of the TSDF volume based on the hyperprior model, wherein the sign information of the TSDF volume is entropy-encoded based on probability distribution information of the latent vector obtained through the hyperprior model.

In the above-described embodiments, although the methods have been described based on flowcharts as a series of steps or units, the present disclosure is not limited to the sequence of the steps and some steps may be performed in a sequence different from that of the described steps or simultaneously with other steps. Further, those skilled in the art will understand that the steps shown in the flowchart are not exclusive and may further include other steps, or that one or more steps in the flowchart may be deleted without departing from the scope of the disclosure.

The above-described embodiments include examples in various aspects. Although all possible combinations for indicating various aspects cannot be described, those skilled in the art will appreciate that other combinations are possible in addition to explicitly described combinations. Therefore, it should be understood that the present disclosure includes other replacements, changes, and modifications belonging to the scope of the accompanying claims.

The above-described embodiments according to the present disclosure may be implemented as a program that can be executed by various computer means and may be recorded on a computer-readable storage medium. The computer-readable storage medium may include program instructions, data files, and data structures, either solely or in combination. Program instructions recorded on the storage medium may have been specially designed and configured for the present disclosure, or may be known to or available to those who have ordinary knowledge in the field of computer software.

A computer-readable storage medium may include information used in the embodiments of the present disclosure. For example, the computer-readable storage medium may include a bitstream, and the bitstream may contain the information described above in the embodiments of the present disclosure.

The computer-readable storage medium may include a non-transitory computer-readable medium.

Examples of the computer-readable storage medium include all types of hardware devices specially configured to record and execute program instructions, such as magnetic media, such as a hard disk, a floppy disk, and magnetic tape, optical media, such as compact disk (CD)-ROM and a digital versatile disk (DVD), magneto-optical media, such as a floptical disk, ROM, RAM, and flash memory. Examples of the program instructions include machine code, such as code created by a compiler, and high-level language code executable by a computer using an interpreter. The hardware devices may be configured to operate as one or more software modules in order to perform the operation of the present disclosure, and vice versa.

As described above, although the present disclosure has been described based on specific details such as detailed components and a limited number of embodiments and drawings, those are merely provided for easy understanding of the entire disclosure, the present disclosure is not limited to those embodiments, and those skilled in the art will practice various changes and modifications from the above description.

Accordingly, it should be noted that the spirit of the present embodiments is not limited to the above-described embodiments, and the accompanying claims and equivalents and modifications thereof fall within the scope of the present disclosure.

What is claimed is:

1. A method for encoding a TSDF volume, the method comprising:
lossily encoding magnitude information of a Truncated Signed Distance Field (TSDF) volume based on a hyperprior model; and
losslessly encoding sign information of the TSDF volume based on the hyperprior model,
wherein the lossy encoding comprises selecting and entropy-encoding some elements from a latent vector for the TSDF volume based on selection information obtained through the hyperprior model.

2. The method of claim 1, wherein the lossy encoding comprises:
converting the TSDF volume into a latent vector and converting the latent vector into a hyperprior vector for the hyperprior model; and
decoding the hyperprior vector to generate the selection information and probability distribution information of the latent vector.

3. The method of claim 2, wherein the lossy encoding comprises entropy-encoding the hyperprior vector based on a distribution according to a factorized prior model to generate a hyperprior bitstream.

4. The method of claim 2, wherein the selected elements of the latent vector are entropy-encoded based on probability distribution information of the selected elements, among the probability distribution information of the latent vector.

5. The method of claim 2, wherein the lossy encoding comprises generating sign probability information of the TSDF volume based on the selection information.

6. The method of claim 5, wherein the lossless encoding comprises entropy-encoding the sign information of the TSDF volume based on the sign probability information to generate a sign bitstream.

7. A method for decoding a TSDF volume, the method comprising:
lossily decoding magnitude information of a TSDF volume based on a hyperprior model; and
losslessly decoding sign information of the TSDF volume based on the hyperprior model,
wherein the lossy decoding comprises:
deriving selected elements of a latent vector of the TSDF volume from a bitstream by entropy-decoding the bitstream based on probability distribution information for the latent vector, the probability distribution information being obtained through the hyperprior model; and
generating sign probability information and magnitude information of voxels constituting the TSDF volume based on selection information for the latent vector obtained through the hyperprior model and the selected elements of the latent vector.

8. The method of claim 7, wherein the lossy decoding comprises:
entropy-decoding the bitstream to generate a hyperprior vector for the hyperprior model; and
decoding the hyperprior vector to generate the selection information and the probability distribution information.

9. The method of claim 7, wherein the generating of the sign probability information and the magnitude information comprises performing an operation on the selection information and the selected elements of the latent vector to reconstruct the latent vector to an original dimension.

10. The method of claim 7, wherein the lossless decoding comprises obtaining the sign information of the TSDF volume by entropy-decoding the bitstream based on the sign probability information.

11. The method of claim 7, further comprising obtaining the TSDF volume by multiplying the magnitude information and the sign information of the TSDF volume.

12. An apparatus for encoding a TSDF volume, the apparatus comprising:
a memory that stores data and one or more instructions; and
one or more processors for executing the one or more instructions stored in the memory,
wherein, by executing the one or more instructions, the one or more processors are configured to:
lossily encode magnitude information of a Truncated Signed Distance Field (TSDF) volume based on a hyperprior model, wherein some elements of a latent vector for the TSDF volume are selected and entropy-encoded based on selection information obtained through the hyperprior model, and
losslessly encode sign information of the TSDF volume based on the hyperprior model,
wherein the sign information of the TSDF volume is entropy-encoded based on probability distribution information of the latent vector obtained through the hyperprior model.
